(19) United States
(12) Patent Application Publication
(10) Pub. No.: US 2014/0010367 A1
(43) Pub. Date: Jan. 9, 2014

(54) SYSTEMS AND METHODS FOR PROVIDING CONTENT TO A WIRELESS DISPLAY SCREEN

(71) Applicant: CHANGLIANG WANG, Bellevue, WA (US)

(72) Inventor: CHANGLIANG WANG, Bellevue, WA (US)

(21) Appl. No.: 13/542,294

(22) Filed: Jul. 5, 2012

(51) Int. Cl. H04N 7/167

(52) U.S. Cl. 380/210

(57) ABSTRACT

Systems and methods are described for minimizing power consumption of a mobile user device that transfers content from an internal or external memory module to a wireless display. The content may be encrypted to secure against unauthorized access and encoded to compress the memory size of the content for transmission to other devices. In certain instances, the mobile user device may not be the ideal display device for the content. For example, a user may want a movie to be played on a bigger screen. In this case, the mobile user device may provide the encrypted and encoded content to a wireless display for decryption and decoding. In this way, the mobile user device may not decrypt or decode the content prior to transmitting the content to the mobile user device. Thereby, the mobile user device saves power by foregoing the aforementioned processing.

### TECHNICAL FIELD

This disclosure generally relates to systems and methods for reducing power requirements for a mobile device that provides content to a wireless display screen.

### BACKGROUND

Mobile devices have become an integral part of the computing landscape. As mobile devices become more capable they have shifted to perform tasks that have traditionally been performed by non-mobile computers. However, mobile, devices must deal with constraints that are not a concern for non-mobile computers. In particular, mobile devices are constrained by their finite power supply. Mobile devices are tasked to perform increasingly complex and power intensive operations that were once the sole domain of their non-mobile counterparts. However, systems and methods developed for non-power constrained devices are not easily transferable to the finite power capabilities of mobile devices. Accordingly, as mobile devices take on more complex operations there is a need to develop low power systems and methods to account for mobile device power supply limitations.

### BRIEF DESCRIPTION OF THE FIGURES

The features within the drawings are numbered and are cross-referenced with the written description. Generally, the first numeral reflects the drawing number where the feature was first introduced, and the remaining numerals are intended to distinguish the feature from the other notated features within that drawing. However, if a feature is used across several drawings, the number used to identify the feature in the drawing where the feature first appeared will be used. Reference will now be made to the accompanying drawings, which are not necessarily drawn to scale and wherein:

FIG. 1 is a block diagram of a representative environment of a wireless network including a user device, a server, and a wireless display that presents content provided by the user device in accordance with one or more embodiments of the disclosure.

FIGS. 2 and 3 illustrate a flow diagram of a method for providing content to a wireless display from a mobile user device and a server in accordance with one or more embodiments of the disclosure.

FIG. 4 is a flow diagram illustrating several interactions between various devices to provide content for a wireless display using power saving techniques in accordance with one or more embodiments of the disclosure.

FIG. 5 is another flow diagram illustrating several interactions between various modules to provide content for a wireless display using power saving techniques in accordance with one or more embodiments of the disclosure.

FIG. 6 is a flow diagram illustrating an exemplary method to process content on a wireless display in accordance with one or more embodiments of the disclosure.

FIG. 7 is a flow diagram illustrating an exemplary method to provide content from a mobile user device in accordance with one or more embodiments of the disclosure.

### DETAILED DESCRIPTION OF EMBODIMENTS OF THE INVENTION

Embodiments of the invention are described more fully hereinafter with reference to the accompanying drawings, in which embodiments of the disclosure are shown. This disclosure may, however, be embodied in many different forms and should not be construed as limited to the embodiments set forth herein; rather, these embodiments are provided so that this disclosure will be thorough and complete, and will fully convey the scope of the disclosure to those skilled in the art.

Embodiments described in this disclosure may provide systems and methods for processing content on the wireless display to minimize power consumption of a mobile device that may provide the content to the wireless display. Broadly, the disclosure describes techniques for minimizing mobile device power consumption by placing power intensive operations on devices that may not be constrained by their power supply.

Mobile devices may perform as content conduits or remote computing devices for full screen displays instead of presenting content on smaller mobile devices displays. In some instances, users may prefer to view movies and videos on larger display screens. Movies and videos may be optimized to be displayed on larger display screens even though they are stored on or provided by smaller mobile user devices. Mobile devices may be constrained by their power supply capabilities that may limit their ability to process content for an extended time period without recharging. In contrast, the larger displays may not have the same power limitations as the mobile devices if they are plugged into an electrical outlet. In short, the power consumption of a mobile device may be reduced by configuring the non-power constrained devices to perform operations normally completed on the mobile device.

In one embodiment, a content providing system may include a content server, a mobile user device, and a wireless display. The content server may store the movies or video that a user wants to view on the wireless display which is larger than the mobile user device display. The content server may compress/encode and encrypt the content before providing it to the user device. The content may be compressed to a smaller memory size to minimize the amount of time needed to transmit and receive the content. Encrypting the content may prevent unauthorized users from copying or viewing content without permission. Generally, the mobile user device may decrypt, decrypt, scale, and display the content on the mobile device. Scaling may be done to transform the content from a first format to a second format. The first format being configured to display on a larger screen while the second format may compatible with displaying the content on a smaller mobile user device screen. This may require a substantial amount of system resources and power to complete these tasks in relation to the limited power supply of the mobile user device. However, when the content is destined for larger wireless display, the content may be scaled to the larger screen size, encoded, and encrypted again on the mobile user device before being wirelessly communicated to the larger wireless display. After receiving the content, the wireless display may decrypt, decode, and display the content.

In another embodiment, when the content requested from the content server, the mobile user device may flag the content to indicate that it may be displayed on the wireless display instead of the mobile user device. In one instance, the content server may encode and encrypt the content and provide the encrypted content to the mobile user device. In turn, the mobile user device may provide the content to the wireless display without decrypting, decoding, or scaling the content. In this way, the mobile user device may minimize its power consumption by not performing the aforementioned operations which are processor and memory intensive. Therefore, the wireless display may also have to scale the content if the incoming format is not compatible or optimized for the larger display screen. Additionally, the wireless display screen may need to implement additional decoding capability that may include, but is not limited to, bi-directional predicted frame techniques to account for the lack of processing done by the mobile device.

Example embodiments of the invention will now be described with reference to the accompanying figures.

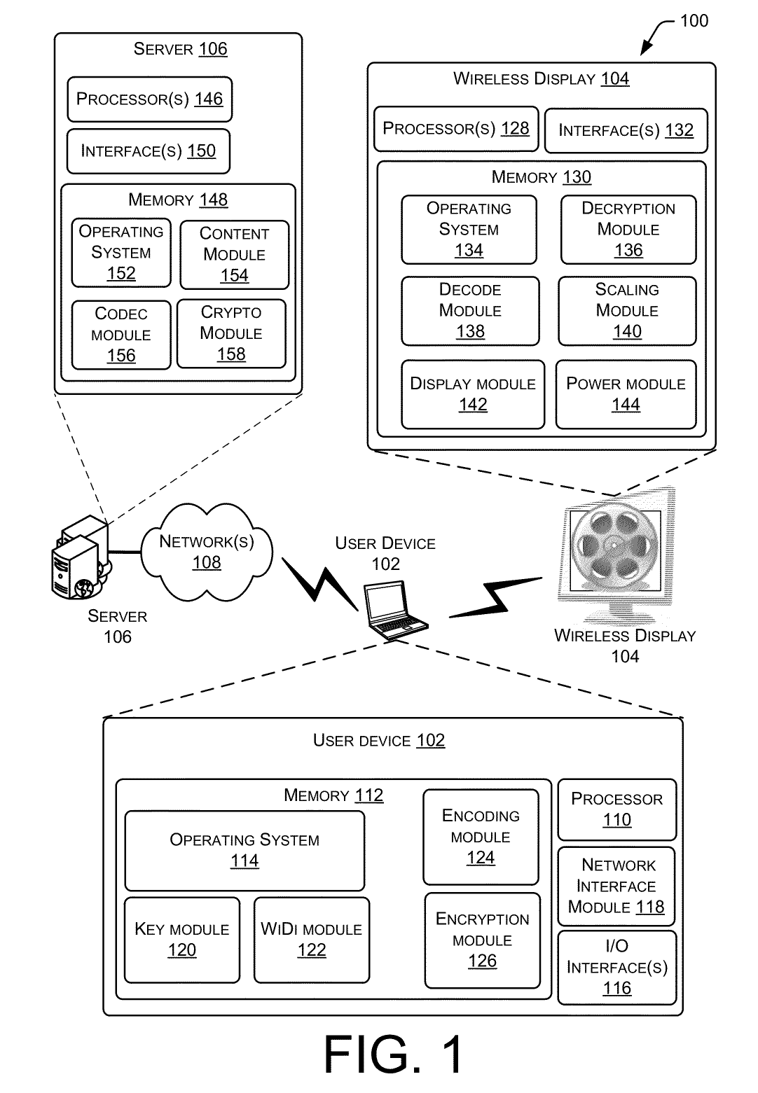

FIG. 1 is a simplified block diagram of a representative environment 100 that includes a mobile user device 102, a wireless display 104, and a server 106 in wireless communication with the mobile user device 102. The server 106 may communicate with the mobile user device 102 over a network 108. At a high level, the mobile user device 102 and the server 106 may interact with each other to exchange content that may be displayed on the mobile user device 102 or the wireless display 104. The server 106 and the wireless display 104 may be configured to receive power from a fixed power outlet and are minimally constrained in terms of power usage. On the other hand, the mobile user device 102 may have a finite power supply that may need to be recharged intermittently. In general, the power saving systems and methods to minimize power consumption of the mobile user device 102 will be introduced by the description of the individual devices shown in FIG. 1.

In one embodiment, the mobile user device 102 may include a computer processor 110 to execute computer-readable instructions stored in memory 112 that enable the mobile user device 102 to execute instructions on the hardware, applications, or services as needed. The one or more computer processors 110 may include, without limitation, a central processing unit (CPU), a digital signal processor (DSP), a reduced instruction set computer (RISC), a complex instruction set computer (CISC), a microprocessor, a microcontroller, a field programmable gate array (FPGA), or any combination thereof. The mobile user device 102 may also include a chipset (not shown) for controlling communications between the one or more processors 110 and one or more of the other components of the mobile user device 102. In certain embodiments, the mobile user device 102 may be based on an Intel® Architecture system and the processor(s) 110 and chipset may be from a family of Intel® processors and chipsets, such as the Intel® Atom® processor family. The one or more processors 110 may also include one or more application-specific integrated circuits (ASICs) or application-specific standard products (ASSPs) for handling specific data processing functions or tasks.

Memory 112 may include an operating system 114 to manage and execute applications stored therein as well as other systems and modules within the mobile user device 102. For example, the mobile user device 102 may include an Input/Output (110) interface 116 that enables a user to view content displayed by the device or to interact with the mobile user device 102 using various tactile responsive interfaces such as a keyboard, display screen, touch screen, and/or mouse. The operating system 114 may also interface with a network interface module 118 that may include a wireless system (not shown) that may enable the mobile user device 102 to communicate wirelessly with the other devices over the network 106. The wireless system may include the hardware and software to broadcast and receive messages either using the Wi-Fi Direct Standard (See; Wi-Fi Direct specification published in October 2010) and or the IEEE 802.11 wireless standard (See; IEEE 802.11-2007, published Mar. 8, 2007; IEEE 802.11n-2009, published October 2009) or a combination thereof. The wireless system may include a transmitter and a receiver or a transceiver (not shown) capable of operating in a broad range of operating frequencies governed by the IEEE 802.11 wireless standards. The wireless system may include an antenna to transmit and receive signals between one or more devices.

The memory 110 may be comprised of one or more volatile and/or non-volatile memory devices including, but not limited to, random access memory (RAM), dynamic RAM (DRAM), static RAM (SRAM), synchronous dynamic RAM (SDRAM), double data rate (DDR) SDRAM (DDR-SDRAM), RAM-BUS DRAM (RDRAM), flash memory devices, electrically erasable programmable read-only memory (EEPROM), non-volatile RAM (NVRAM), universal serial bus (USB) removable memory, or combinations thereof.

The memory 112 may also include one or more modules that may be used to implement content sharing between the mobile wireless device 102 and the wireless display 104. In one embodiment, the mobile user device 102 may include a key module 120, a WiDi module 122, an encoding module 124, and an encryption module 126. These aforementioned modules may be a combination of software, hardware, and/or a combination thereof. For ease of explanation, the modules may be segregated into two embodiments. The first embodiment may include the key module 120 and the WiDi module 122, w bile the second embodiment may include the encoding module 124 and the encryption module 126. The mobile device may implement both embodiments depending on how the mobile user device 102 wants to process the content.

In the first embodiment, the content provided by the server 106 may be flagged for display on the wireless display 104. The content may be encoded in a format that is compatible or optimized for the wireless display 104. The key module 120 may receive the content and extract an encryption key from the encrypted content from the server 106. The encryption key may be used to decrypt or encrypt information such that a key holder may be able to transform the encrypted or unreadable content to decrypted or readable content. The key may be inserted into the encrypted content by the server 106 or any publisher associated with the content. In another instance, the encryption key may be stored on a remote server (not shown) that acts as repository for encryption keys. Additionally, the encryption key may also be provided separately from the encrypted content and may be stored on the mobile user device 102. The encryption key may be accesses by the key module 120 when encrypted content associated with the key arrives at the mobile user device 102. The encryption key may be a part of a Digital Rights Management (DRM) access control technology that is used by hardware manufacturers, content providers, publishers, or copyright holders to limit the use of their products after they are sold.

The WiDi module 124 or content module may receive the encrypted content and determine that the content is flagged to be displayed on the wireless display 104. Alternatively, when the content is not predetermined to play on the wireless display 104 or the display screen of the mobile user device 102, the WiDi module 124 may prompt the user to select which display screen is the target for the encrypted content. In this way, the user may designate which screen may be used to display the content. In one embodiment, the wireless display 104 may be the desired target and the WiDi module 124 passes on the encrypted content to the wireless display 104 without decrypting, decoding, scaling, and/or displaying the content.

In another embodiment, the encrypted content may be processed by the mobile user device 102 be fore being sent to the wireless display 104. The encryption module 126 may decrypt the encrypted content using an encryption key extracted from the content or a previously provided encryption key. Although the content is no longer encrypted, the content may have been compressed prior to encryption and may not be readable and/or viewable. The encoding module 124 may be used to decompress or decode the decrypted content into a readable or viewable format. For example, the encoding module 124 may use one or more type codec (e.g., coder-decoder) to compress or decompress content. One such codec may be the H264 standard developed in conjunction with the International Organization for Standards (ISO) and the Video Coding Experts Group from the Telecommunications Standardization Sector (ITU-T). However, any other codec standard or format may be implemented by the encoding module 124.

Under the H264 standard, the decoding process may involve using predictive algorithms to construct or decompress the video content frames. Under the predictive techniques, the frames may be constructed or decoded based on information gleaned from surrounding frames. In one embodiment, the frames may be classified as I-frames/slices, P-frames/slices, or B-frames/slices.

I-frames or intra-coded picture frames represent a fully specified picture that may not require information from other frames to be decoded. P-frames or predicted picture frames include only the changes in the image from the previous frame. For example, the P-frame may include information related to moving objects in the frame but not to stationary objects. Accordingly, P-frames may use stationary object information from prior frames to decode the current P-frame. The P-frames may be limited to obtaining information from prior frames in the sequence. P-frames may be stored using a smaller amount of memory than the I-frames since the entire P-frame leverage information stored in other frames. B-frames or bi-directional predicted frames may reference both a proceeding frame and a succeeding frame in the sequence of content frames. B-frames may use even less memory than the P-frames since they may leverage information from an additional succeeding frame, not just the preceding frames. B-frame compression is much more complicated and may require more processing than P-frames or I-frames. After being decoded, the content on the mobile user device 102 may be displayed on the smaller mobile user device screen (not shown) or the content may be configured to be displayed on the wireless display 104.

Following the decoding, the content may need to be scaled to be displayed properly on the wireless display 104. The size of the content may be optimized to fit on the smaller mobile user device screen or the larger wireless display screen. The encoding module 124 may include a scaling algorithm that can convert the content from a first dimensional format to a second dimensional format. For example, the first dimensional format may be a low resolution format such as a standard definition format (SDTV) to and the second dimensional format may be a high resolution format such as a high definition format (HDTV). In one embodiment, the scaling may be done on the mobile user device 102. Following the scaling of the content, the content may be prepared for transmission to the wireless display 104.

Before providing the content to the wireless display 104, the content may be encoded by the encoding module 124 and encrypted by the encryption module 126. The same or similar encoding and encryption techniques discussed above may be used in both cases. The content may be provided to the wireless system of the network interface module 118 and wirelessly communicated to the wireless display 104.

The wireless display 104 may receive content from the mobile user device 102 and process the content into a readable and/or viewable format that may be displayed on a display screen of the wireless display 104. This may include, but is not limited to, decrypting, decoding, and scaling the content as will be discussed in greater detail below. The wireless display 104 may implement these embodiments using hardware, software, or a combination thereof.

In one embodiment, the wireless display 104 may include one or more processors 128, memory 130, and interface devices 132 to implement the aforementioned embodiments. The one or more processors 128 may individually comprise one or more cores and are configured to access and execute (at least in part) instructions stored in the one or more memories 130. The one or more memories 130 comprise one or more CRSMs as described above.

Similar to those described above, the one or more interfaces 132 a flow for the coupling of devices such as displays, keyboards, storage devices, and so forth. Likewise, the one or more interfaces 132 may be configured to wirelessly couple to the mobile user device 102 or the network 108. The wireless system (not shown) may include an antenna to transmit and receive signals between one or more devices.

The one or more memories 130 may store instructions for execution by the one or more processors 128 which perform certain actions or functions. These instructions may include an operating system 134 configured to manage hardware resources, such as the interfaces 132, and provide various services to applications executing on the one or more processors 128.

The memory 126 may also include an one or more modules to implement the content viewing capability of the wireless display 104. In one embodiment, the wireless display 104 may include a decryption module 136, a decoding module 138, a scaling module 140, a display module 142, and a power module 144. As high level overview, the content received from the mobile user device 102 may decrypted by the decryption module 136, decoded or decompressed by the decoding module 138, dimensionally reconfigured by the scaling module 138, if needed, and then rendered and displayed via the display module 142. This is assuming the content is encrypted and compressed prior to be sent to the wireless display. If not, then the decryption and decoding operations may be omitted or truncated as needed. Scaling of the content may also be performed as needed.

The decryption module 136 may receive the encryption key and the encrypted content from the mobile user device 102 or server 106. As noted above, any encryption technique may be used to secure the content. The decryption module 136 may be configured to convert the secured content to an unsecured state that is easily readable by the processor 128 on the wireless display 104. However, in one embodiment, the decrypted content may also be encoded or compressed and may not be fully utilized or displayed without further processing.

When the unsecured content is in an encoded state, the decoding module 138 may use any codec technique to decompress the unsecured content to be viewable or renderable on the display screen of the wireless display 104. For example, the unsecure content may be compressed using the H.264 compression standard. In this way, the decoding module 138 may decompress or reconstitute the content using I-frames, P-frames, and B-frames as discussed above the discussion of the encoding module 124. For examples, the content may comprise a sequence of frames arranged in order. The sequence may begin with an I-frame that may not have to reference any other frame to reconstitute itself into a viewable image. In contrast, the P-frames and B-frames may reference near by frames to form a viewable frame. For example, the P-frame may reference a prior frame in the sequence to reconstitute itself into a viewable frame. The B-frame may reference a prior and/or a succeeding frame in the sequence to constitute a viewable frame. In short, the P-frame and B-frame use the differences or lack of differences between the frames to highlight portions of the frame that may not change from one frame to the next. In short, the P-frame and B-frame attempt to leverage stationary portions of the frame to minimize the amount of processing to reconstitute the entire frame. Typically, this type of processing has not been typically done on the wireless display 104. In particular, the B-frame processing has not been completed by the wireless display 104 in the past. In some instances, the decompressed unsecured content may also need to be resized or optimized for the display screen of the wireless display 104.

The scaling module 140 may reconfigure the dimensional characteristics of the content received from the decoding module 138. For example, the content may be configured for a height and width of 1024×768 and the wireless display 104 may need to display the content at 1920×1080. The scaling module 140 may translate the 1024×768 content to the 1920×1080 format to optimize the content for the wireless display screen. Once the content is properly scaled for the wireless display, the content may displayed on the wireless display screen.

The display module 142 may render or display the content on the wireless display screen. The display module 142 may queue the content for display and verify the content configuration is optimized for the display screen. If needed, the display module 142 may provide a user interface to the user that enables the user to adjust the functions or configuration of the display screen. For example, the user may elect to configure the display screen for a higher or lower resolution. In this instance, the display module 142 may communicate the configuration change to the decoding module 138 and the scaling module 140 to process or reprocess the content to comply with the new configuration. For example, the wireless display 104 may be configured for a high resolution to display a high definition movie. However, the user may want to convert the display screen to a lower resolution to view email or to use word or math processing applications. In this instance, the display module 142 may present a user interface to the user that enables the selection of a lower resolution. This configuration change may be passed on to the scaling module 140 to convert the higher resolution content to a lower resolution. Following the conversion, the display module 142 may display the lower resolution content via the display screen.

The power module 144 for the wireless display 104 may be coupled to a fixed power outlet that provides consistent and uninterrupted power. For example, the power outlet may be a fixed wall outlet that provide electrical power from a power source that is external to the wireless display. In contrast, the mobile user device 106 may include an internal power source, such as a battery. Although the wireless display 104 may store power in a battery for back-up purposes or power stabilization purposes, the primary source of power to the wireless display may be the remote power source that may be accessible from the wall outlet proximately located to the wireless display 104.

Turning to the server 106 of the network environment 100, the source of the displayed content may reside externally from the mobile user device 102 and the wireless display 104. In one instance, the content may reside on a server 106 and may be requested by the mobile user device 102 or the wireless display 104. Broadly, the server 106 may be part of a larger network that stores and manages content for a content provider, publisher, or distributor. In one instance, the server 106 may be a part of a cloud network that is accessible via the network 108.

The server 106 may include one or more processors 146, memory 148, and interface devices 150 to implement the aforementioned embodiments. The one or more processors 146 may individually comprise one or more cores and are configured to access and execute (at least in part) instructions stored in the one or more memories 148. The one or more memories 140 comprise one or more CRSMs as described above.

Similar to those described above, the one or more interfaces 150 allows for the coupling of devices such as displays, keyboards, storage devices, and so forth. Likewise, the one or more interfaces 150 may be configured to couple to the network 108.

The one or more memories 148 may store instructions for execution by the one or more processors 146 which perform certain actions or functions. These instructions may include an operating system 152 configured to manage hardware resources, such as the interfaces 150, and provide various services to applications executing on the one or more processors 146.

In one embodiment, the memory 148 may include a content module 154, a codec module 156, and a crypto module 158. The content module 154 may store and manage content that may be provided to users over the network 108. For example, the content may include audio, video, or any other type of audio-visual content that may be viewed on a display screen. The content may include movies, television shows, personal video content, music, music videos, or any other type of content that may stored in an electronic, digital, or analog format.

The codec module 154 may encode or compress the content prior to transmitting the content to the mobile user device 102. The encoding translates the content from a first format that is viewable to a second format that is compresses the content to a smaller memory size to reduce the amount of memory content that is transferred over the network 108. This may reduce the likelihood that the content may be lost or corrupted during transmission and may shorten the amount of time to deliver the content. In one instance, the content may be encoded per the H.264 standard for video compression.

In another embodiment, the encoded content may also be encrypted to limit unauthorized access to the content when the content is transmitted over the network 108. The crypto module 158 encrypt the content using any DRM technology or any other type of cryptography that may be implemented on the content that is transmitted over the network 108. The crypto module 158 may also generate an encryption key or cipher that is associated with the encrypted content. The key or cipher may be provided to authorized users to enable them to decrypt the content. The key or cipher may be embedded into the encrypted content or sent separately from the content and stored on the mobile user device 102, the wireless display 104, or a remote key server (not shown) that acts as a repository of encryption keys. Once the content is secured, the server 106 may provide the requested content to the mobile user device 102. In another instance, the server 106 may provide the content directly to the wireless display 104 and may bypass the mobile device 104. In this case, the mobile user device 104 may request the content from the server 106 and direct the server 106 to send the content directly to the wireless display 104. In this way, the mobile user device 102 reduces power consumption by not having to act as conduit for the content or process the content since the wireless display 104 may be configured to decrypt, decode, and scale the content without processing support from the mobile user device 102.

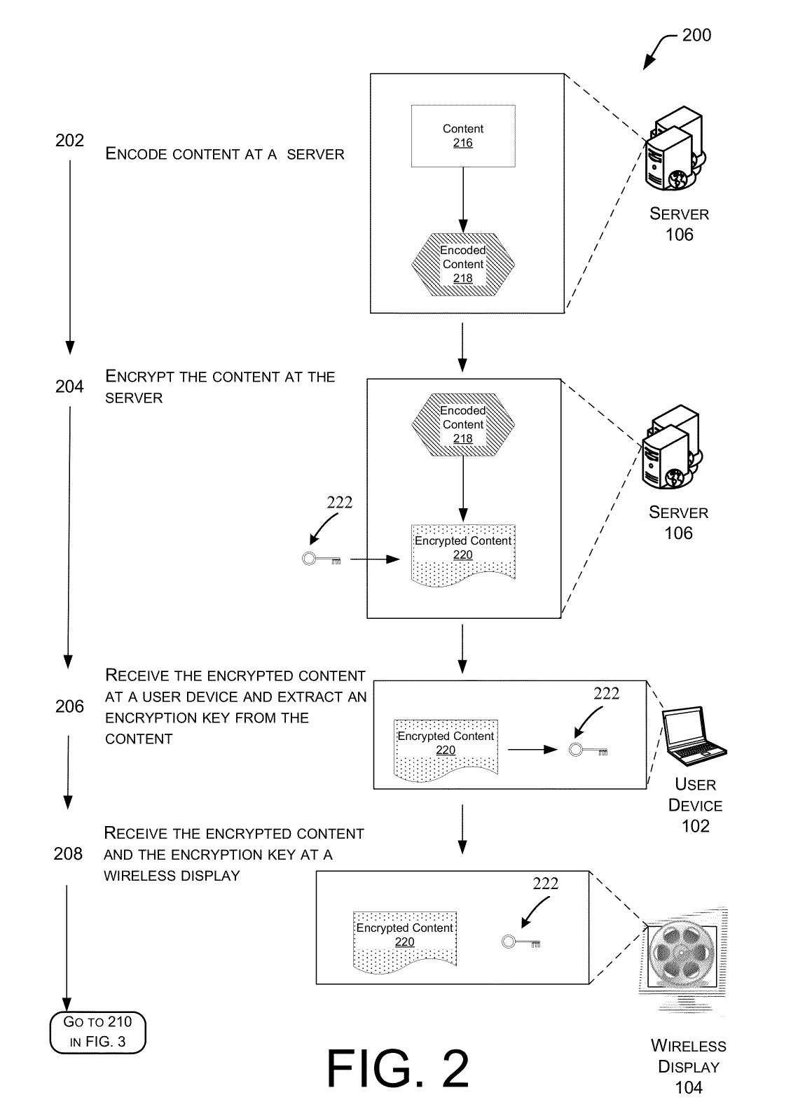

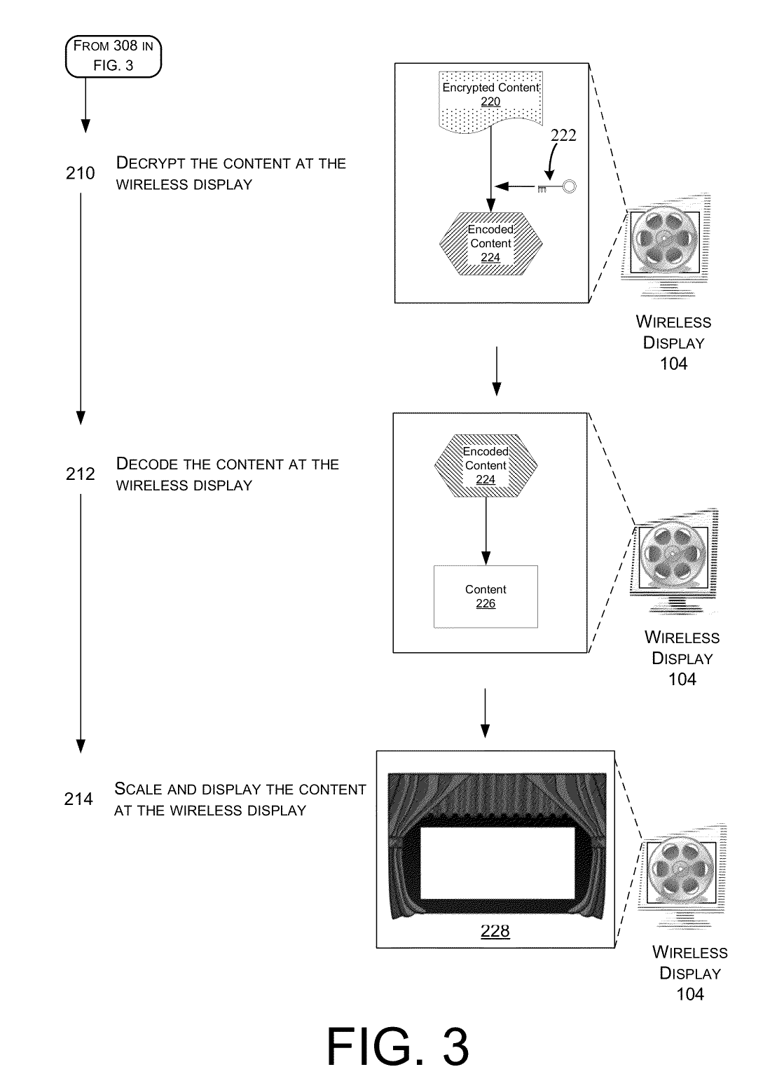

FIGS. 2 and 3 are a flow diagram 200 of a method for providing content to a wireless display 104 from a mobile user device 102 and a server 106. FIGS. 2 and 3 include illustrations to the right of the method description that are a pictorial representation of the method being implemented by one or more of the aforementioned devices.

At block 202, when the server 106 receives a request for content 216 the codec module 156 may encode or compress the content 216 to a smaller memory size. The encoding process may be implemented using the H264 encoding standard that transforms the content from a fully, viewable or readable format to a compressed format that is not readily viewable in the compressed state. The codec module 156 may select a predetermined encoding profile that may implemented or compatible with the mobile user device 102 and/or the wireless display 104. For examples, the profiles may include, but are not limited to, constrained baseline profile, progressive high profile, or high 4:4:4 predictive profile. Once the content 216 has been encoded, the encoded content 218 may need to be secured or encrypted prior to transmission. However, in certain instances, the encryption process may be omitted.

At block 204, the encoded content 218 may be provided to the crypto module 158 to be encrypted using any DRM technology or any other encryption technique for electronic content. The encrypted content 220 may be secure against unauthorized access when it is transmitted over the network 108. The crypto module 158 may also generate an encryption key 222 that is associated with the encrypted content 220. In one embodiment, the crypto module 158 may generate an encryption key that is uniquely associated with each piece of content. In another embodiment, the encryption key 222 may apply to more than one piece of content being transmitted over the network 108. For example, the encryption key may be a single common key that is used by all parties. However, the encryption key may also include a set of keys in which a group key may be used to encrypt the content and individual private keys may be used to decrypt the content. The group key may be used by multiple users while the private key may be restricted to a single user. The distribution of the encryption keys may also take place in several ways. In one embodiment, the encryption key 222 may be embedded into the encrypted content 220. Alternatively, the encryption key 222 may be sent separately from the content to the recipient or to a remote storage server that may be accessed as needed.

At block 206, the mobile user device 102 may receive the encrypted content 220. In one embodiment, the key module 120 may extract the embedded encryption key 222 from the encrypted content 220. In another embodiment, the encryption key 222 may already reside on the mobile user device 102. In an additional embodiment, the encryption key 222 may be stored remotely and accessed by the mobile user device 102 on an as needed basis. To minimize power consumption, the mobile user device 102 may not decrypt or decode the encrypted content 220. Following the encryption process, the encrypted content may be considered in a secure state and may be transmitted to other devices in a secure manner.

At block 208, the wireless display 104 may receive the encrypted content 220 and the encryption key 222 from the mobile user device 102. In another embodiment, as noted above, the wireless display may already have the encryption key 222 or it may have been provided separately from the encrypted content 220. For example, the encryption key may be stored in memory 130 or it may be requested from a remote server (not shown) that acts as a key repository for the mobile user device 102 or the wireless display 104.

At block 210, the wireless display 104 may decrypt the encrypted content to generate the encoded content 224, which is not fully viewable on the display screen in this state. As noted above in FIG. 1, the encoded content 224 may be an indication that the content is in a compressed state for transmission purposes. In this instance, the content may need to undergo additional processing in order to be placed in a viewable or displayable form.

At block 212, the decode module 138 may transform the encoded content 224 to a viewable or displayable content state 226. However, the displayable content 226 may not be optimized for the configuration of the display screen. In some instances, additional processing may be required as described in block 214. However, in another embodiment, the method of block 212 may be omitted and the method may proceed directly to block 214 after decoding is completed.

At block 214, the scale module 140 may reconfigure the content 226 to be compatible or optimized for the display screen or for the level of resolution that may be predetermined by the user or the manufacturer of the wireless display 104. For example, the content 226 may have been configured for a first dimensional format (e.g., 1024×768) but the display screen is capable of presenting the content in a second format (e.g., 1920×1080). The scale module 140 may convert the content 226 from the first format to the second format. Then, the wireless display 104 may present the decrypted, decoded, and scaled content 228 on the display screen for the viewer.

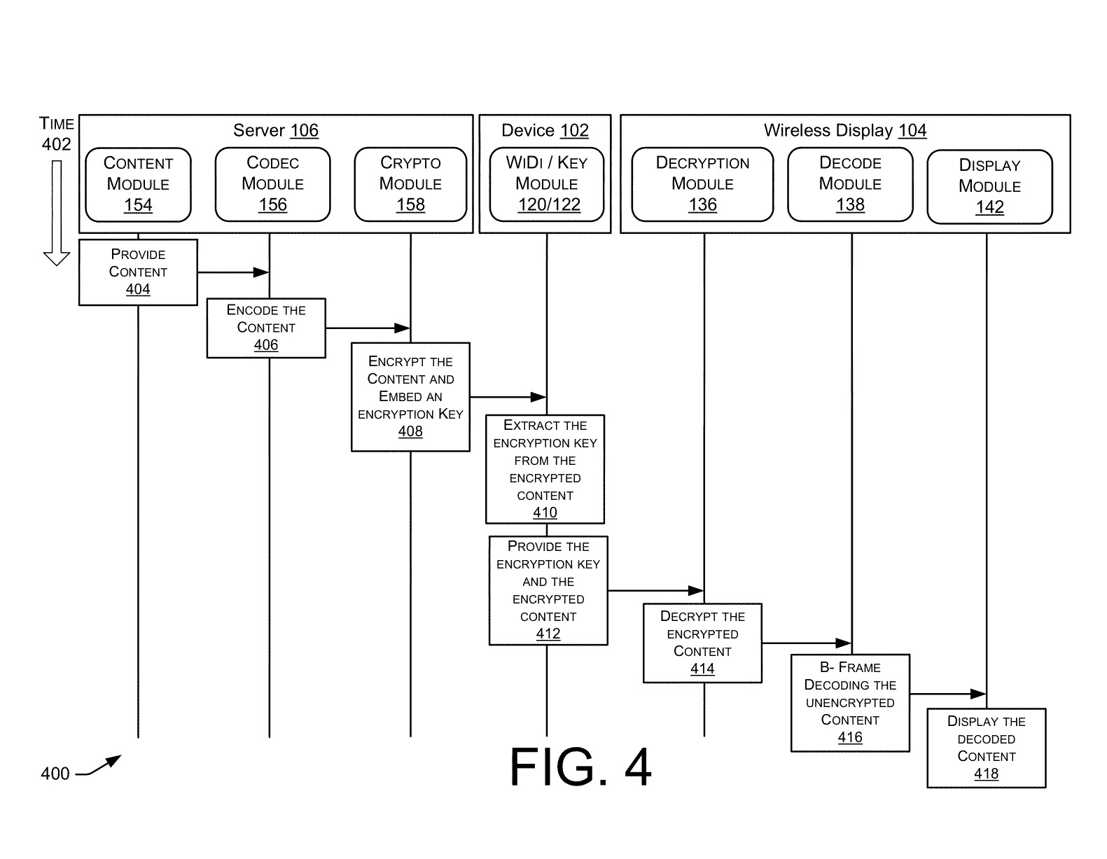

FIG. 4 is a flow diagram 400 illustrating several interactions between various devices to provide content for a wireless display 104 via a mobile user device 102 and a server 106. The flow diagram 400 shows a time axis 402 indicating the relative sequencing of these events for this embodiment. It should be noted that in other embodiments, the sequencing may be altered and some modules may be omitted. The description of FIG. 4 below is for one embodiment and additional embodiments that may use different steps and sequencing to implement the method.

At block 404, the content module 154 may receive a request for content and initiate the processing of the content so that it may be transmitted over the network 108. In this embodiment, the requested content may be encoded and encrypted prior to transmission. The content may include any type of content that may be electronically stored or transmitted. For example, the content may be a movie that is currently configured for standard definition in a 1024×768 configuration. However, the content may be configurable to a higher resolution and a different aspect ratio.

At block 406, the codec module 156 may receive the content and encode the content using any type of encoding standard for compressing video. In one embodiment, the codec module 156 may encode the movie using the H.264 encoding standard using a constrained baseline profile. However, in other embodiments, additional H.264 profiles may be used in addition to any other encoding standard besides the H.264 standard.

At block 408, the crypto module 158 may encrypt the encoded content using any type of DRM or encryption techniques that are known in the art. The crypto module 158 may generate an encryption key that is associated with the encrypted content. In one embodiment, the encryption key may be a single key that is shared between all senders and recipients of the content. In another embodiment, the encryption key may include a public key for all senders to encrypt content and a private key that is associated with recipient that uses the private key to decrypt the content. In practice, the public key may be used collectively by the group to encrypt content. However, a corresponding private key that may be unique to each user may be used to decrypt the content.

At block 410, the mobile user device 102 may receive the encrypted content at the key module 120 and/or the WiDi module 122. The key module 122 may extract the encryption key from memory 130 or from the movie and provide it to the WiDi module 122 that associates the encryption key with the encrypted content.

At block 412, the WiDi module 122 may initiate a wireless connection with the wireless display 104 and transmit the encrypted content and the encryption key. The WiDi module 122 may initiate the wireless connection via the network interface module 122 that may include a wireless system that may transmit and receive content in compliance with the IEEE 802.11 communications standard.

At block 414, the decryption module 136 may receive the encrypted content and use the encryption key to decrypt the content to generate the encoded content. As noted above, the encryption key may be sent with the content or, in the alternative, the encryption may have been received separately from the content and stored in memory 130.

At block 416, the decode module 138 de code the encoded content using encoding/decoding techniques that may be associated with the content. In this embodiment, this may include the H.264 encoding standard that was used by the server 106 to originally encode the content. In one embodiment, the compressed content may be represented by a sequence of frames that include all of the information to generate the viewable content (e.g., the movie). As noted above in FIG. 1, the frames may be designated as I-frames, P-frames, and B-frames. In this instance, the I-frames include all the information to be properly decoded and converted to a viewable format. However, the P-frames and B-frames may need to reference other frames in order to gather all the information to fully decode the frame to make it fully viewable on the display screen. For example, these P and B frames may rely on information stored in other frames that may be incorporated into the instant frame. Hence, the memory size of the P and B frames are generally smaller than the viewable frames or the 1-frames. In particular, the P-frames may reference a prior frame in the sequence to obtain information to generate a fully viewable frame, while B-frames may reference a prior frame and a succeeding frame in the sequence to obtain information to generate a fully viewable frame. For example, a sequence of frames for a movie may include a portion that includes moving objects and stationary objects. In practice, the stationary objects may be leveraged from frame to frame since they do not change. Therefore, the processing for portions of the frame that do not change may not have to be processed repeatedly. Accordingly, the processing time and resources may be reduced by using more P-frames and B-frames such that the wireless display 104 may forgo having to decode the entirety of every single frame for the entire sequence.

At block 418, the display module 142 may receive the decoded or viewable content and display and/or render the content on the display screen for the wireless display. In this embodiment, the user may be able to view the movie that was stored on the server 106 on the wireless display.

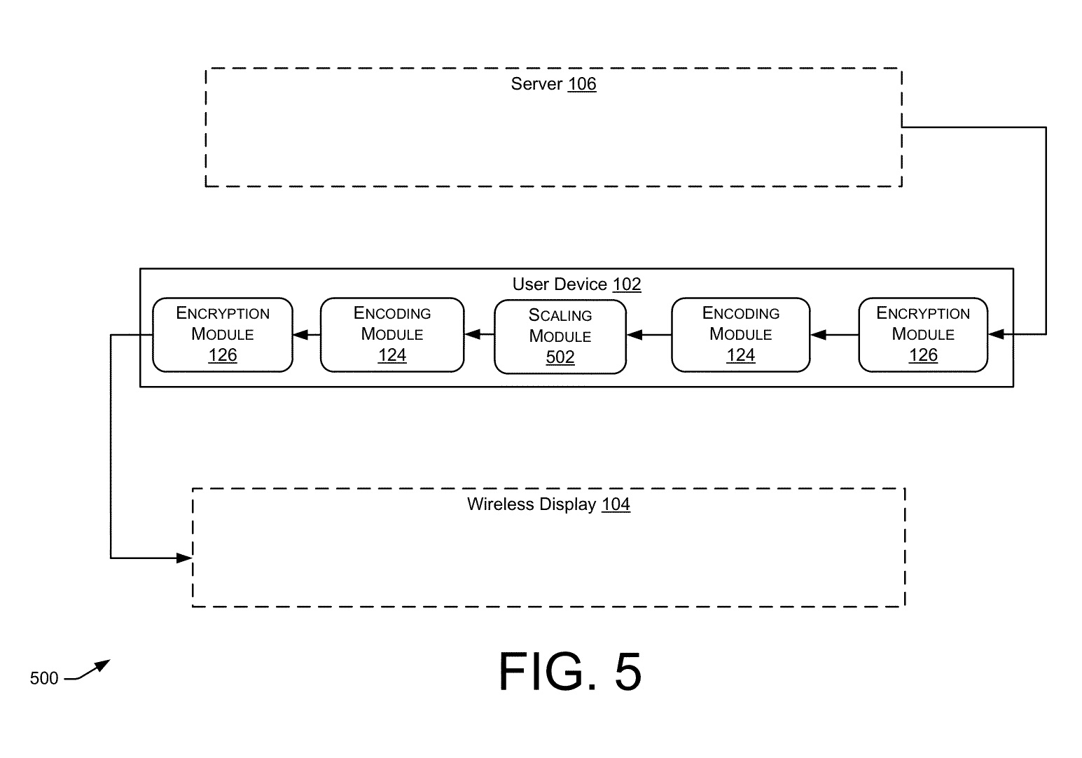

FIG. 5 is another flow diagram 500 illustrating another method to provide content for a wireless display 104 via a mobile user device 102 and a server 106. The FIG. 5 embodiment illustrates another embodiment that may cause the mobile user device 102 to use more power to transfer content from the server 106 to the wireless display 104. As such, the description of FIG. 5 will focus on the mobile user device 102 as it receives content from the server 106 and provides content to the wireless display. The wireless display 104 and the server 106 are shown in dashed outline to provide the context in which the operations of the mobile user device 102 are performed. The operations performed by the wireless device 104 and the server 106 may be similar to the operations already described in FIGS. 1, 2, 3, and 4.

Turning to FIG. 5, the mobile wireless device 102 may receive encrypted content 220 from the server 106. The encryption module 126 may decrypt the encrypted content 220 to generate the encoded content. In turn, the encoding module 124 may decode the content to generate fully viewable content. In this embodiment, the fully viewable content may need to be scaled to be properly displayed on the wireless display 104. The scaling module 502 may convert the content from one format (e.g., 1024×768) to another format (e.g., 1920×1080). Following the conversion, the reformatted content may be encoded by the encoding module 124 and encrypted by the encryption module 126 before being provided to the wireless display 104. In this embodiment, although not illustrated here in FIG. 5, the content may require additional processing (e.g., decryption, decoding, and/or scaling as described in FIGS. 1 and 4) by the wireless display 104 before the content may be displayed on the display screen.

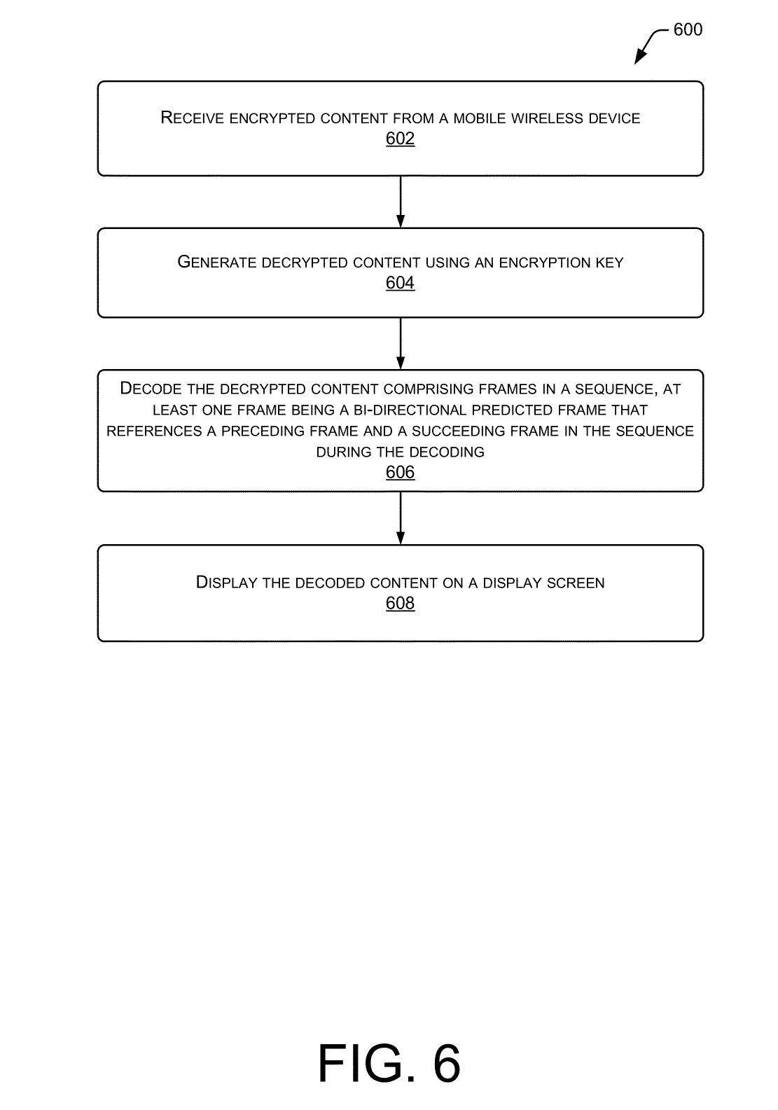

FIG. 6 is a flow diagram 600 illustrating an exemplary method to process content on a wireless display 104 that is received from a mobile user device 102. In this embodiment, the mobile user device 102 may provide encrypted content to the wireless display 104. The content may need to be processed to generate displayable content. For example, the received content may be encrypted, encoded, and/or scaled to an undesirable format. Flow diagram 600 illustrates one embodiment in which the wireless display may process the content received from the mobile user device 104.

At block 602, the wireless display 104 may receive encrypted content 220 from a mobile user device 102 or a server 106 over a wireless connection. The content may include audio, video, image, and/or text data that may be displayed on the display screen of the wireless display 104. For example, the content may include a movie that is configured for 1024×0768. However, the wireless display 104 may have the capability to display the movie at 1920×1080. The decryption may be performed on the wireless display 104 using the decryption module 136 as discussed above in FIG. 1.

In this embodiment, the movie may be stored in its entirety on the wireless display 104. The movie content may not need to be streamed from the mobile user device 102 or the server 106 while the movie is being displayed on the wireless display 104. Accordingly, the wireless display 104 may be configured with sufficient memory 130 to store one or more content items in their entirety.

At block 604, the wireless display 104 may decrypt the encrypted content 220 to reveal that the movie has been compressed into an encoded format to reduce the amount of memory that is needed to transfer the movie from one device (e.g., the server 106) to another device (e.g., the wireless display 104). The decryption process may include using an encryption key as discussed above in FIG. 4.

At block 606, the encoded content 224 may be decoded using the decode module 138 as discussed above in FIG. 1. For example, the decode module 138 may use the H.264 encoding standard to convert the encoded content 224 into viewable content 226. As noted above in FIG. 1, the decoding process may involve processing a sequence of frames that represent images within the movie. The processing may include decompressing the frames that have been compressed to a smaller memory state by identifying common information between frames and saving that information as needed within a few amount of frames rather than saving all the common information for all frames. The decoding process will reconstitute the frames with the common information or may use that common information to assist in decompressing the frames. In one embodiment, the decode module 138 may make use of the I-frame, P-frame, and B-frame techniques described above in FIG. 1. In particular, the decode module 138 of the wireless display 104 may use the B-frame technique to reference a prior or succeeding frames in the sequence to decode or decompress a frame. The B-frame technique may use information from those frames to decode another frame to form a fully viewable frame of the movie. When the sequence of frames is decoded they may be viewed in their entirety as the movie.

In another embodiment, the decoded frames may also be reformatted using the scaling module 140. For example, the movie may be reformatted from a 1024×0768 resolution to a 1920×1080 resolution. The level of resolution may be dependent upon the amount of detailed image data within each frame. In this instance, the sequence of frames include sufficient information to display the movie at the higher or lower resolution mentioned above.

At block 608, the display module 142 may use the decoded sequence of frames to display the content 228 or movie on the display screen. In one embodiment, when the user is finished with the movie, the wireless display 104 encode and encrypt the movie and transmit the movie wirelessly to the mobile user device 102 for storage purposes. In another embodiment, the mobile user device 102 may transfer the movie back to the server 106 for storage or to another remote memory device that is in electrical communication with the mobile user device 102.

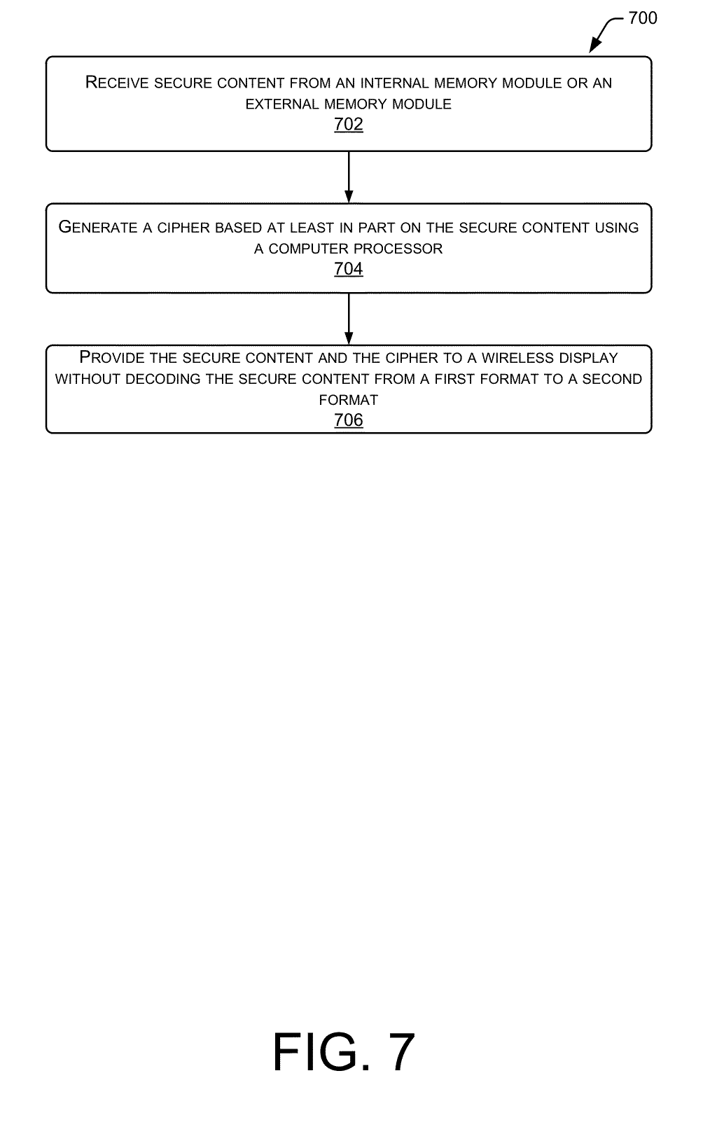

FIG. 7 is a flow diagram 700 illustrating an exemplary method to provide content from a mobile user device 102 to a wireless display 104. In this embodiment, the mobile user device 102 may request content from the server 106. The content may be provided to the mobile user device 102, but the user intends to view the content using a wireless display 104. In this instance, the mobile user device 102 may act as a conduit between the server 106 and the wireless display 104. By limiting the amount of processing of content on the mobile user device 102, the amount of power consumed by the mobile user device 102 is minimized.

At block 702, the mobile user device 102 may receive the secure content from server 104 that is accessible via the network 108. The content may be encrypted for security purposes using any known encryption or DRM technology. In some instances, the content may also be encoded or compressed prior to encryption. The compression techniques are helpful in minimizing the memory size of the content by making it more compact for transmission purposes. This may reduce the amount of time and resources needed to transfer the content from device to device.

In another embodiment, the content may come from an internal memory module (e.g., Hard Disk Drive or Flash memory) of the mobile user device that stores content or can read content from mobile memory devices (e.g., Digital Video Disc).

At block 704, the mobile user device 102 may generate a cipher key that may be used to decrypt the encrypted content. The key module 120 may extract the cipher from the encrypted content or the provider of the encrypted content may send a cipher separately from the encrypted content. The mobile user device 102 may include a native display screen, but the user may want to view the content on a larger screen for aesthetic reasons or to segregate content viewing from other activities (e.g., work related applications, social media, and/or web browsing). The mobile user device 102 may establish a wireless link with the wireless display 104 using the network interface module 118.

At block 706, using the wireless link, the mobile user device 102 may transmit the encrypted content to the wireless display 104. In one embodiment, the encrypted content 220 is received by the mobile user device 102 and provided to the wireless display 104 without decrypting, decoding, or scaling the encrypted content 220. In another embodiment, the content may not be received by the mobile user device 102 in an encrypted format, however, the content may be in an encoded or compressed format. In this instance, the encoded content may be transmitted from the mobile user device 102 to the wireless display 102 without decoding the content. As noted above in FIG. 6, the wireless display 104 may be configured to decrypt, decode, and scale the content that is being passed on by the mobile user device 102.

### CONCLUSION

Embodiments described herein may be implemented using hardware, software, and/or firmware, for example, to perform the methods and/or operations described herein. C ertain embodiments described herein may be provided as a tangible machine-readable medium storing machine-executable instructions that, if executed by a machine, cause the machine to perform the methods and/or operations described herein. The tangible machine-readable medium may include, but is not limited to, any type of disk including floppy disks, optical disks, compact disk read-only memories (CD-ROMs), compact disk rewritables (CD-RWs), magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, magnetic or optical cards, or any type of tangible media suitable for storing electronic instructions. The machine may include any suitable processing or computing platform, device or system and may be implemented using any suitable combination of hardware and/or software. The instructions may include any suitable type of code and may be implemented using any suitable programming language. In other embodiments, machine-executable instructions for performing the methods and/or operations described herein may be embodied in firmware.

Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications.

The terms and expressions, which have been employed herein, are used as terms of description and not of limitation. In the use of such terms and expressions, there is no intention of excluding any equivalents of the features shown and described (or portions thereof), and it is recognized that various modifications are possible within the scope of the claims. Other modifications, variations, and alternatives are also possible. Accordingly, the claims are intended to cover all such equivalents.

While certain embodiments of the invention have been described in connection with what is presently considered to be the most practical and various embodiments, it is to be understood that the invention is not to be limited to the disclosed embodiments, but on the contrary, is intended to cover various modifications and equivalent arrangements included within the scope of the claims. Although specific terms are employed herein, they are used in a generic and descriptive sense only, and not for purposes of limitation.

This written description uses examples to disclose certain embodiments of the invention, including the best mode, and to enable any person skilled in the art to practice certain embodiments of the invention, including making and using any devices or systems and performing any incorporated methods. The patentable scope of certain embodiments of the invention is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

The claimed invention is:

1. A device comprising:
a wireless network interface to receive encrypted content from a mobile device comprising an internal power supply;
a decryption module to generate decrypted content from the encrypted content using an encryption key;
a decode module to decode the decrypted content using an arrangement of picture frames comprising one or more bi-predicted picture frames that reference a p receding frame and a succeeding frame in the arrangement; and
a display screen to display the arrangement of picture frames.

2. The device of claim 1, further comprising a scaling module to convert the arrangement of picture frames from a first resolution to a second resolution.

3. The device of claim 2, wherein the decoding of the decrypted content comprises a predicted picture frame that can be decoded without referencing another frame in the arrangement of picture frames and an intra-coded picture frame that references a preceding frame in the arrangement of picture frames.

4. The device of claim 1, wherein the decryption module is to receive the encryption key from the mobile device.

5. A mobile device comprising:
a content module to receive encrypted content from an external memory module or an internal memory module;
a key module to receive an encryption key associated with the encrypted content; and
a wireless interface module to provide the encryption key and the encrypted content to a wireless display without decrypting, decoding, or scaling the encrypted content.

6. The device of claim 5, further comprising a display screen to provide a user interface to configure the wireless interface module to wirelessly communicate with the wireless display.

7. The device of claim 6, wherein the encrypted content is a first plurality of encrypted content, and the device further comprising:
a decryption module to generate decrypted content from a second plurality of encrypted content received from the external memory module or the internal memory module;
a decoding module to generate decoded content from the decrypted content, the decoded content being translated from a first format to a second format;
a scaling module to scale the decoded content from a first resolution to a second resolution; and
a graphics processor to render the decoded content onto a display screen of the mobile device.

8. A method comprising:
receiving encrypted content from a wireless mobile device using a network interface device;
generating decrypted content from the encrypted content using an encryption key; and
decoding the decrypted content comprising one or more frames arranged in a sequence, at least one frame being a bi-directional predicted frame that references a preceding frame and a succeeding frame in the sequence during the decoding.

9. The method of claim 8, further comprising scaling the decoded content from a first resolution to a second resolution.

10. The method of claim 8, further comprising:
displaying the decoded content on a display screen; and
scaling the decoded content from a first dimensional configuration to a second dimensional configuration.

11. The method of claim 8, wherein the decoding further comprises using a predicted picture frame that begins the sequence and an intra-coded picture frame that references a preceding frame in the sequence during the decoding.

12. The method of claim 8, wherein the referencing of the preceding frame and the succeeding frame for the bi-directional picture frame comprises using the difference between the preceding frame and the succeeding frame to generate content of the bi-directional frame.

13. The method of claim 11, wherein the referencing of the preceding frame for the intra-coded picture frame comprises using a portion of the preceding frame to generate content of the intra-coded picture frame.

14. The method of claim 8, further comprising receiving the encryption key from the wireless mobile device.

15. One or more tangible computer-readable storage media comprising computer-executable instructions operable to, when executed by at least one computer processor, enable the at least one computer processor to implement a method comprising:
receiving secure content from a wireless mobile device;
generating unsecure content from the secure content using a cipher;
decoding the unsecure content comprising one or more frames arranged in a sequence, at least one frame being a bi-directional predicted frame that references a preceding frame and a succeeding frame in the sequence during the decoding; and
displaying the decoded content on a display screen.

16. The one or more tangible computer-readable storage media of claim 15, further comprising scaling the decoded content from a first resolution to a second resolution.

17. The one or more tangible computer-readable storage media of claim 15, further comprising scaling the decoded content from a first dimensional configuration to a second dimensional configuration.

18. The one or more tangible computer-readable storage media of claim 15, wherein the decoding further comprises using a predicted picture frame that begins the sequence and an intra-coded picture frame that references a preceding frame in the sequence during the decoding.

19. The one or more tangible computer-readable storage media of claim 15, wherein the referencing of the preceding frame and the succeeding frame for the bi-directional picture frame comprises using the difference between the preceding frame and the succeeding frame to generate content of the bi-directional frame.

20. The one or more tangible computer-readable storage media of claim 18, wherein the referencing of the preceding frame for the intra-coded picture frame comprises using a portion of the preceding frame to generate content of the intra-coded picture frame.

21. A method comprising:
receiving secure content from an internal memory module of a mobile device or an external memory module;
receiving a cipher associated with the secure content; and
providing the secure content and the cipher to a wireless display device without decoding the secure content from a first format to a second format.

22. The method of claim 21, wherein the secure content is a first plurality of secure content, and the method further comprising:
deciphering a second plurality of secure content received from the internal memory module of the mobile device or the external memory module;
translating the deciphered content from the first format to the second format;
a scaling module to scale the decoded content from a first dimensional configuration to a second dimensional configuration; and
a graphics processor to render the translated content onto a display screen of the mobile device.

23. One or more tangible computer-readable storage media comprising computer-executable instructions operable to, when executed by at least one computer processor, enable the at least one computer processor to implement a method comprising:
receiving secure content from an internal memory module of a m obile device or an external memory module;
generating a cipher based at least in part on the secure content using a computer processor; and
providing the secure content and the cipher to a wireless display device without decoding the secure content from a first format to a second format.

24. The one or more tangible computer-readable storage media of claim 23, wherein the secure content is a first plurality of secure content, and the computer-readable storage media further comprising:
deciphering a second plurality of secure content received from the internal memory module of the mobile device or the external memory module;
translating the deciphered content from the first format to the second format;
a scaling module to scale the decoded content from a first dimensional configuration to a second dimensional configuration; and
displaying the translated content onto a display screen of the mobile device.

25. A system comprising:
a wireless network interface to receive encrypted content from a mobile device comprising an internal power supply using an antenna;
a decryption module to generate decrypted content from the encrypted content using an encryption key using a processor;
a decode module to decode the decrypted content using an arrangement of picture frames comprising one or more bi-predicted picture frames that reference a p receding frame and a succeeding frame in the arrangement; and
a display screen to display the arrangement of picture frames.

26. The system of claim 25, further comprising a scaling module to convert the arrangement of picture frames from a first resolution to a second resolution.

27. The system of claim 26, wherein the decoding of the decrypted content comprises a predicted picture frame that can be decoded without referencing another frame in the arrangement of picture frames and an intra-coded picture frame that references a preceding frame in the arrangement of picture frames.
